(19) United States
(12) Patent Application Publication
(10) Pub. No.: US 2024/0393992 A1
(43) Pub. Date: Nov. 28, 2024

(54) INFORMATION PROCESSING SYSTEM, NON-TRANSITORY COMPUTER READABLE MEDIUM, AND INFORMATION PROCESSING METHOD

(71) Applicant: FUJIFILM Business Innovation Corp., Tokyo (JP)

(72) Inventor: Shuhei TODA, Kanagawa (JP)

(73) Assignee: FUJIFILM Business Innovation Corp., Tokyo (JP)

(21) Appl. No.: 18/502,566

(22) Filed: Nov. 6, 2023

(30) Foreign Application Priority Data
May 24, 2023 (JP) 2023-085783

(51) Int. Cl. G06F 3/12

(52) U.S. Cl. CPC G06F 3/1238; G06F 3/1204; G06F 3/1222; G06F 3/1261

(57) ABSTRACT

An information processing system includes: a processor configured to: receive printing information and a condition, the printing information including data serving as a printing target, the condition being for managing a state of the data; and in response to nonsatisfaction of the condition in outputting the received printing information, give a report suggesting a measure for satisfying the condition.

### CROSS-REFERENCE TO RELATED APPLICATIONS

This application is based on and claims priority under 35 USC 119 from Japanese Patent Application No. 2023-085783 filed May 24, 2023.

### BACKGROUND

### (i) Technical Field

The present disclosure relates to an information processing system, a non-transitory computer readable medium, and an information processing method.

### (ii) Related Art

Japanese Unexamined Patent Application Publication No. 2011-015323 discloses an image forming apparatus that stores pieces of fax transmission data to be subjected to fax transmission, the pieces of fax transmission data each being stored in association with a corresponding one of senders. The image forming apparatus includes an input unit, a fax-transmission-data output unit, a print-data generation unit, and a print-data output unit. The input unit receives the input of permission information or non-permission information regarding fax transmission for each of the pieces of fax transmission data. If the input unit receives the input of the permission information regarding one of the pieces of fax transmission data, the fax-transmission-data output unit outputs the permitted piece of fax transmission data to perform the fax transmission. If the input unit receives the non-permission information regarding one of the pieces of fax transmission data, the print-data generation unit generates print data in accordance with the not permitted piece of fax transmission data. The print-data output unit outputs the print data generated by the print-data generation unit to display the print data as print data for the corresponding sender if the sender logs in the image forming apparatus.

Japanese Unexamined Patent Application Publication No. 2011-135210 discloses an image forming apparatus that stores pieces of fax transmission data to be subjected to fax transmission, the pieces of fax transmission data each being stored in association with a corresponding one of senders. The image forming apparatus includes an input unit, a fax-transmission-data output unit, a print-data generation unit, a list display unit, a print-data selection unit, a reason determination unit, and an output unit. The input unit receives the input of permission information or non-permission information regarding fax transmission for each of the pieces of fax transmission data, the non-permission information including a reason for the non-permission. If the input unit receives the input of the permission information regarding one of the pieces of fax transmission data, the fax-transmission-data output unit outputs the permitted piece of fax transmission data to perform the fax transmission. If the input unit receives the non-permission information regarding one of the pieces of fax transmission data, the print-data generation unit generates first print data associated with the sender in accordance with the not permitted piece of fax transmission data. If the sender logs in the image forming apparatus, the list display unit displays a list of pieces of first print data associated with the sender and generated by the print-data generation unit. The print-data selection unit selects one of the pieces of first print data to be processed with the list display unit. The reason determination unit determines the reason for the non-permission included in the non-permission information regarding the piece of first print data selected by the print-data selection unit as indicating whether retransmission with stored fax transmission data is allowed or not allowed. If the reason determination unit determines that the reason for the non-permission indicates that retransmission is allowed, the output unit outputs one of the pieces of fax transmission data that corresponds to the piece of first print data selected by the print-data selection unit to cause the fax-transmission-data output unit to transmit the piece of fax transmission data. If the reason determination unit determines that the reason for the non-permission indicates that retransmission is not allowed, the reason determination unit outputs the piece of first print data selected by the print-data selection unit to print the piece of first print data.

### SUMMARY

There are information processing systems with which once an administrator approves printing target data of which approval is requested by a user, the user is allowed to print the printing target data. In such an information processing system, once the administrator gives approval, the user is allowed to print the data in various situations after the approval by using the data. In this case, the confidentiality of the data is not ensured in some situations, and it is not necessarily possible for the administrator to manage the states of printing performed by the user to ensure the confidentiality of the data.

Aspects of non-limiting embodiments of the present disclosure relate to an information processing system, a non-transitory computer readable medium, and an information processing method by which an administrator is allowed to manage a state of printing target data handled by a user.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing system including: a processor configured to: receive printing information and a condition, the printing information including data serving as a printing target, the condition being for managing a state of the data; and in response to nonsatisfaction of the condition in outputting the received printing information, give a report suggesting a measure for satisfying the condition.

### BRIEF DESCRIPTION OF THE DRAWINGS

An exemplary embodiment of the present disclosure will be described in detail based on the following figures, wherein:

FIG. 1 is a view illustrating an overview of an information processing system according to this exemplary embodiment;

FIG. 2 is a block diagram illustrating an example of the configuration of client computers, a mobile terminal, and a cloud server according to this exemplary embodiment;

FIG. 3 is a block diagram illustrating an example of the configuration of an image forming apparatus according to this exemplary embodiment;

FIG. 4 is a flowchart illustrating operations performed when the client computer registers printing information in the printing management system;

FIG. 5 is a view illustrating an example of a display screen displayed on one of the client computers;

FIG. 6 is a flowchart illustrating the operations of the printing management system;

FIG. 7 is a view illustrating an example of a display screen displayed when approval conditions are set;

FIG. 8 is a flowchart illustrating operations in a detailed process related to the approval conditions;

FIG. 9 is a view illustrating an example of a report displayed on the mobile terminal;

FIG. 10 is a view illustrating another example of the report displayed on the mobile terminal;

FIG. 11 is a view illustrating another example of the report displayed on the mobile terminal;

FIG. 12 is a view illustrating another example of the report displayed on the mobile terminal;

FIG. 13 is a flowchart illustrating the operations of the mobile terminal;

FIG. 14 is a view illustrating an example of a display screen displayed on the mobile terminal;

FIG. 15 is a flowchart illustrating operations in a detailed process for printing information having the approval conditions added thereto;

FIG. 16 is a view illustrating an example of a display screen displayed on the mobile terminal;

FIG. 17 is a view illustrating an example of a report displayed on the mobile terminal;

FIG. 18 is a view illustrating another example of the report displayed on the mobile terminal; and

FIG. 19 is a view illustrating another example of the report displayed on the mobile terminal.

### DETAILED DESCRIPTION

Hereinafter, an example of an exemplary embodiment of the present disclosure will be described with reference to the drawings.

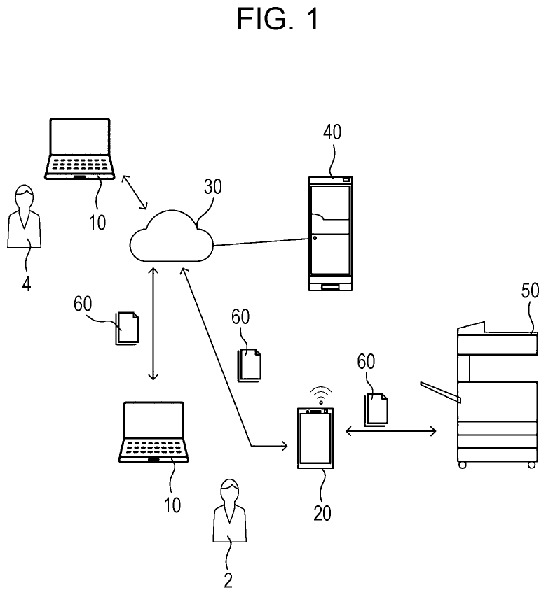

First, an overview of this exemplary embodiment will be described with reference to FIG. 1.

FIG. 1 illustrates client computers 10, a mobile terminal 20, a printing management system 30 on the cloud system, and an image forming apparatus 50. The printing management system 30 is provided on the cloud system by, for example, a cloud server 40.

The client computers 10, the mobile terminal 20, and the printing management system 30 are connected to each other via a communication network that is, for example, one of various networks. The mobile terminal 20 is connected to the image forming apparatus 50 via the communication network as occasion demands.

The example in FIG. 1 illustrates the client computers 10 used by, for example, a user 2 and the client computer 10 used by an administrator 4 who is a superior or the like of the user 2. Regardless of the example illustrated in FIG. 1, one client computer 10 or further more client computers 10 may be connected. In the example in FIG. 1, the one mobile terminal 20 used by the user 2 and one cloud server 40 are illustrated, but one or more mobile terminals 20 and one or more cloud servers 40 may be connected.

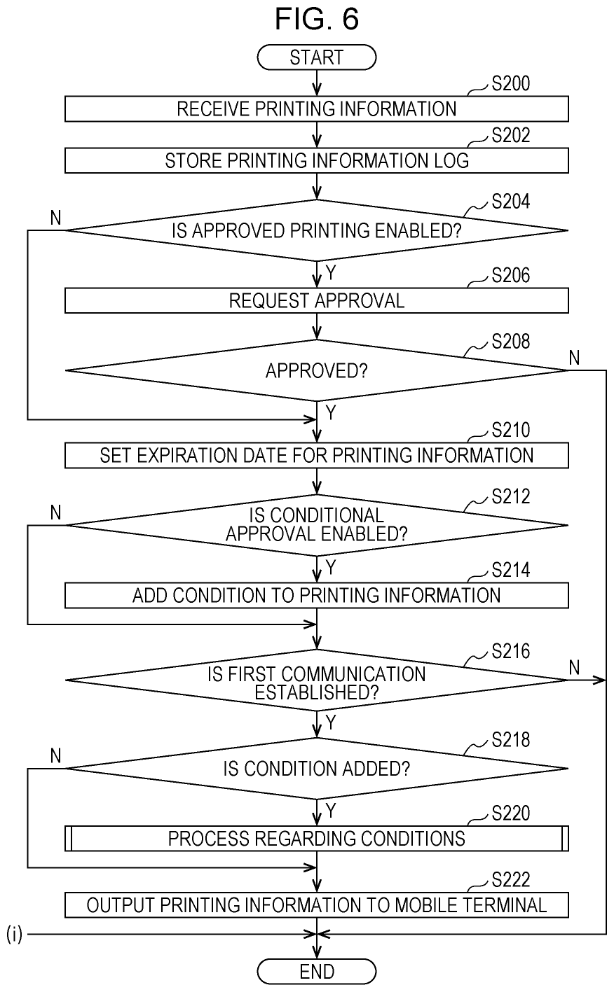

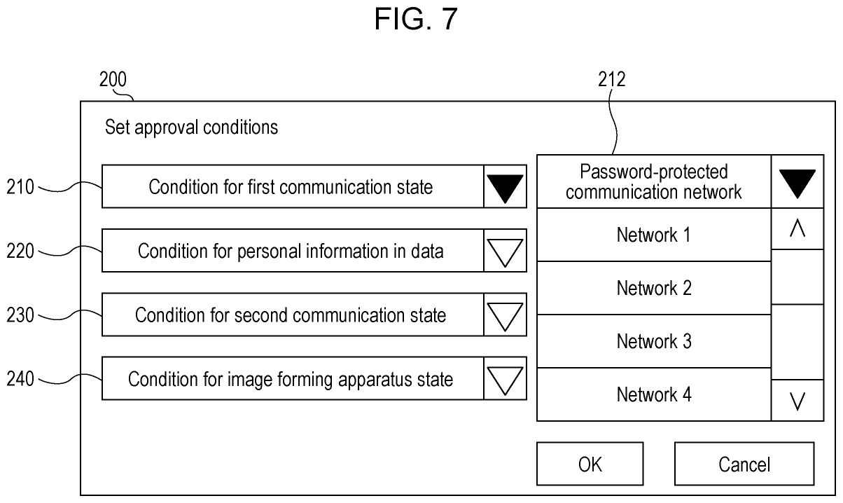

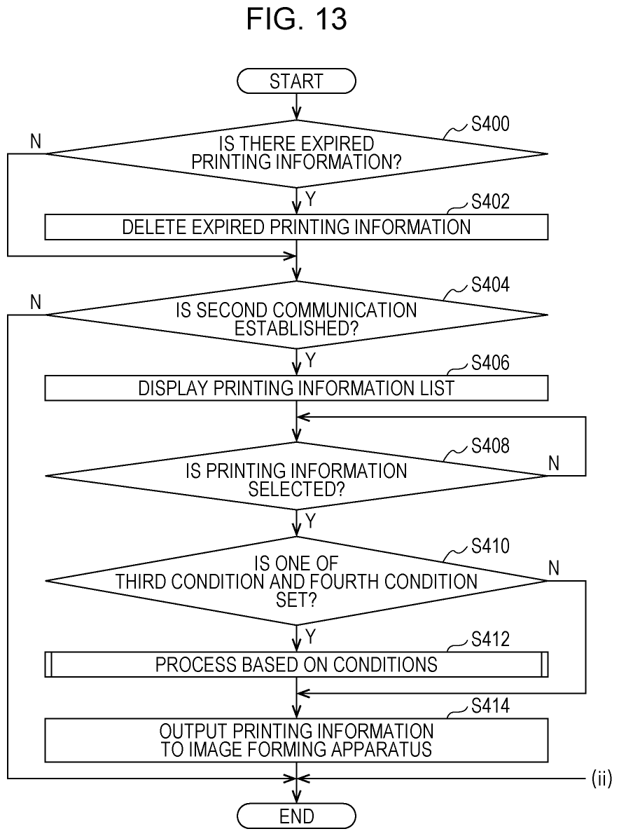

In this exemplary embodiment, the user 2 registers printing information including data 60 serving as a printing target in the printing management system 30 by using the client computer 10. If an approved printing function that is a service provided by the printing management system 30 is enabled, the printing management system 30 outputs a report requesting the approval of the printing of the registered printing information to the client computer 10 of the administrator 4. The details of a process of the approved printing function will be described later (see FIG. 6). If a conditional approval printing function that is a service provided by the printing management system 30 is enabled, the printing management system 30 adds an approval condition to be described in detail later to printing information the approval request of which is accepted by the administrator 4 and outputs the printing information to the mobile terminal 20 (see FIGS. 6 and 7). In response to the connection of the mobile terminal 20 having received the printing information to the image forming apparatus 50, for example, through operation by the user 2, the mobile terminal 20 outputs the printing information to the image forming apparatus 50 (see FIGS. 13 to 20). The image forming apparatus 50 having received the printing information prints the data 60 included in the printing information. Each of the cloud server 40 and the mobile terminal 20 is an example of an information processing system.

The configurations of each client computer 10, the mobile terminal 20, and the cloud server 40 illustrated in FIG. 1 will then be described.

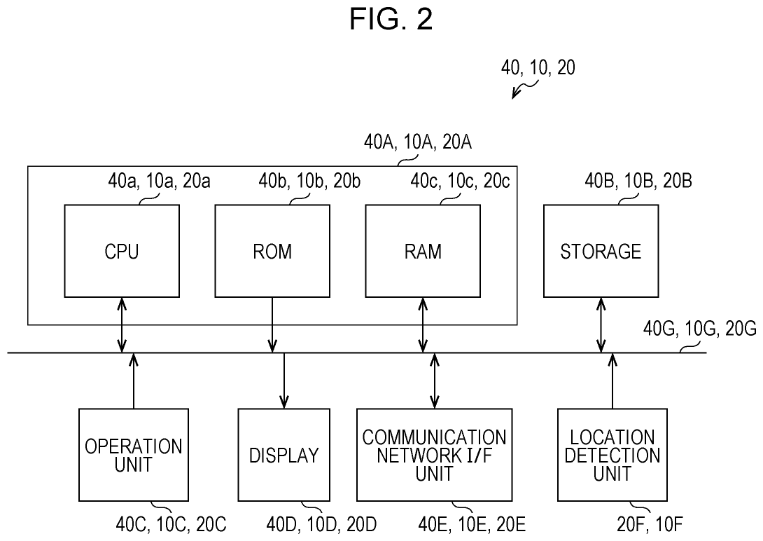

FIG. 2 is a block diagram illustrating the configuration of each of the client computer 10, the mobile terminal 20, and the cloud server 40 according to this exemplary embodiment. The client computer 10, the mobile terminal 20, and the cloud server 40 have a general computer configuration, and thus the cloud server 40 will be described below as a representative.

As illustrated in FIG. 2, the cloud server 40 according to this exemplary embodiment includes a processor 40A, a storage 40B, an operation unit 40C, a display 40D, and a communication network interface (I/F) unit 40E. The processor 40A includes a central processing unit (CPU) 40a, a read only memory (ROM) 40b, and a random access memory (RAM) 40c and takes in charge of overall operations of the cloud server 40. The ROM 40b in advance stores various control programs, various parameters, and the like. The RAM 40c is used as a work area or the like at the time when the CPU 40a runs various programs. The storage 40B stores various pieces of data, application programs, and the like. The operation unit 40C is used to input various pieces of information. The display 40D is used to display the various pieces of information. The communication network I/F unit 40E is an interface to transmit and receive various pieces of data to and from an external apparatus. The communication network I/F unit 40E may be configured to be able to directly communicate with apparatuses by using the near field communication such as Wi-Fi (registered trademark) or Bluetooth (registered trademark). The components as described above of the cloud server 40 are mutually electrically connected via a system bus 40G. In the cloud server 40 according to this exemplary embodiment, the storage 40B is applied to a memory, but a nonvolatile memory such as a hard disk drive (HDD) or a flash memory is applied to an example of a storage.

The client computer 10 may include a location detection unit 10F in addition to components corresponding to the components of the cloud server 40 described above. The location detection unit 10F detects the location of the client computer 10 with a global positioning system (GPS) or the like. The mobile terminal 20 may include a location detection unit 20F in addition to components corresponding to the components of the cloud server 40 described above. The location detection unit 20F detects the location of the mobile terminal 20 with the GPS or the like.

A processor 10A, a processor 20A, and the processor 40A are an example of a processor.

The configuration of the image forming apparatus 50 according to this exemplary embodiment will then be described.

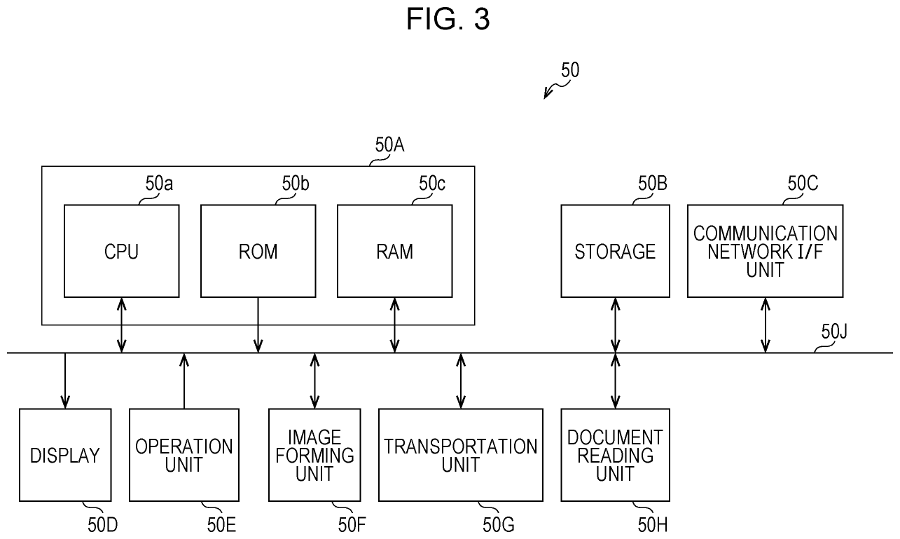

FIG. 3 is a block diagram illustrating the configuration of the image forming apparatus 50 according to this exemplary embodiment.

As illustrated in FIG. 3, the image forming apparatus 50 according to this exemplary embodiment includes a processor 50A, a storage 50B, a communication network I/F unit 50C, a display 50D, an operation unit 50E, an image forming unit 50F, a transportation unit 50G, and a document reading unit 50H.

The processor 50A includes a CPU 50a, a ROM 50b, and a RAM 50c. The CPU 50a takes in charge of overall operations of the image forming apparatus 50. The RAM 50c is used as a work area or the like at the time when the CPU 50a runs various programs. The ROM 50b in advance stores various information processing programs, various parameters, and the like.

The storage 50B stores various pieces of data, application programs, and the like. The display 50D is a user interface that displays various operation screens and the like. The operation unit 50E detects a designation operation by a user who uses the image forming apparatus 50. The display 50D and the operation unit 50E are discriminated from each other in the description in this exemplary embodiment, but a touch panel or the like serving as the display 50D and the operation unit 50E may be applied.

The document reading unit 50H includes a charge-coupled device (CCD) image sensor or the like, for example, for executing a document reading process and generates a document image from a document set, for example, on the image forming apparatus 50. The image forming unit 50F forms an image of printing target data or the document image generated by the document reading unit 50H on the recording medium such as a paper sheet by using, for example, an inkjet recording system or an electrophotographic system. The transportation unit 50G transports a sheet yet to be subjected to the image forming, a sheet subjected to the image forming of data, a document, or the like.

The communication network I/F unit 50C is an interface that transmits and receives data by communicating with the image forming apparatus 50 and an external apparatus such as the mobile terminal 20. The processor 50A, the storage 50B, the communication network I/F unit 50C, the display 50D, the operation unit 50E, the image forming unit 50F, the transportation unit 50G, and the document reading unit 50H are electrically connected via a system bus 50J.

The operations of the client computer 10 performed when the user 2 registers printing information in the printing management system 30 will then be described.

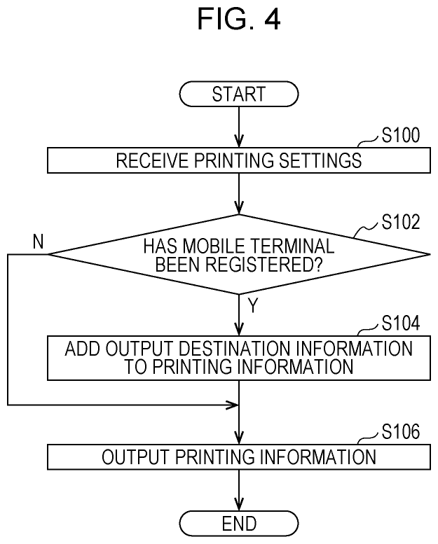

FIG. 4 is a flowchart illustrating the operations performed when the client computer 10 registers the printing information in the printing management system 30. The operation illustrated in FIG. 4 is performed in response to the start of an application program for the printing management system 30. In the following description, steps S100 to S106 below are performed by the processor 10A, but at least one step may be performed by the processor 40A.

In step S100, the processor 10A receives printing settings for printing target data. The printing settings are designation of, for example, the size of a printed material, color printing or monochrome printing, and the like. The printing settings are performed by the user 2.

In step S102, the processor 10A determines whether the mobile terminal 20 serving as an printing-information output destination has been registered in the printing management system 30. In detailed description, for example, the user 2 may in advance register the mobile terminal 20 serving as the printing-information output destination in the printing management system 30. In response to the processor 10A acquiring the information regarding the mobile terminal 20 registered in advance in the printing management system 30, the processor 10A may thereby perform determination in step S102. The mobile terminal 20 registered in advance serves as a candidate for a destination to output the printing information.

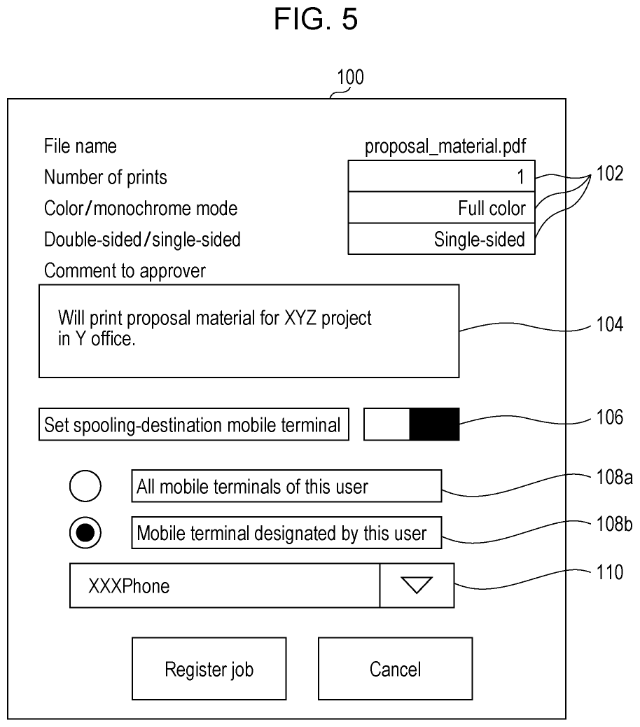

If the mobile terminal 20 has been registered (YES in step S102), the processor 10A performs step S104. If the mobile terminal 20 has not been registered in the printing management system 30 (NO in step S102), the processor 10A performs step S106. FIG. 5 illustrates an example of a screen displayed on a display 10D in step S102.

A display screen 100 illustrated in FIG. 5 includes a printing setting 102 received in step S100. For example, if the approved printing function is enabled, the display screen 100 includes a comment 104 to the administrator 4 that is received in setting the printing. If the mobile terminal 20 has been registered in step S102, an output-destination mobile terminal setting 106 that is enabled is displayed. If the output-destination mobile terminal setting 106 is enabled, the user 2 may designate the mobile terminal 20 to output the printing information by using a designation field 108a and a designation field 108b. For example, if multiple mobile terminals 20 are registered in the printing management system 30, and if the printing information is to be output to all of the mobile terminals 20, the designation field 108a is selected. To designate the mobile terminal 20 as the output destination, the designation field 108b is selected, and the mobile terminal 20 as the destination to output the printing information is designated from the multiple mobile terminals 20 in a designation field 110.

In step S104, the processor 10A adds the information regarding the mobile terminal 20 as the printing-information output destination to the printing information. Specifically, if the mobile terminal 20 is designated in the designation field 110 illustrated in FIG. 5, the processor 10A adds, to the printing information, for example, the identification code, the serial number, the MAC address, or the like of XXXPhone indicating the mobile terminal 20 designated in the designation field 110. If the designation field 108a is selected, the processor 10A adds, to the printing information, for example, the identification code, the serial number, the MAC address, or the like of each mobile terminal 20 registered in the printing management system 30. This causes the printing information to be output to the mobile terminal 20 having the added identification code when the printing information is output to the mobile terminal 20. Outputting the printing information to the mobile terminal 20 includes outputting by spooling.

In step S106, the processor 10A outputs the printing information to the printing management system 30.

The operations of the printing management system 30 performed if the printing management system 30 receives the printing information output from the client computer 10, in other words, after the process in FIG. 4 is performed will then be described.

FIG. 6 is a flowchart illustrating the operations of the printing management system 30. A process illustrated in FIG. 6 is executed by an application program stored in the cloud server 40.

In step S200, the processor 40A receives the printing information output from the client computer 10.

In step S202, the processor 40A stores the log of the received printing information. In other words, the processor 40A stores the records of the received printing information.

In step S204, the processor 40A determines whether the approved printing function is enabled. Whether the approved printing function is enabled or disabled is set in advance by, for example, the administrator 4. If the approved printing function is set enabled (YES in step S204), the processor 40A performs step S206. If the approved printing function is set disabled (NO in step S206), the processor 40A performs step S210.

In step S206, the processor 40A outputs, to the client computer 10 used by, for example, the administrator 4, a report requesting approval of the printing of registered printing information (hereinafter, referred to as an approval request report). The administrator 4 having received the approval request report decides whether to approve the printing of the printing information to be performed, for example, by the user 2. The administrator 4 makes the decision with the client computer 10 used by the administrator 4. The administrator 4 then makes a response to the approval request report.

In step S208, the processor 40A determines whether the printing is approved in response to the approval request report. If the printing is approved (YES in step S208), the processor 40A performs step S210. If the printing is not approved (NO in step S208), the processor 40A terminates the series of steps.

Step S206 and step S208 are an example of the process of the approved printing function.

In step S210, the processor 40A sets an expiration date for the printing information. The expiration date is calculated on the basis of, for example, a period set in advance in the printing management system 30 by the administrator 4.

In step S212, the processor 40A determines whether the conditional approval printing function is enabled. Whether the conditional approval printing function is enabled or disabled is set in advance, for example, by the administrator 4. With the conditional approval printing function, the administrator 4 may set approval conditions in the printing management system 30 in advance. The approval conditions in the approved printing function and approval condition setting will be described with reference to FIG. 7.

The administrator 4 may set the approval conditions in advance in the printing management system 30 with a display screen 200 illustrated in FIG. 7. The approval conditions are conditions set for managing the state of the printing information included in the data 60.

The administrator 4 may set a condition for communication between the printing management system 30 and the mobile terminal 20 (hereinafter, referred to as first communication) by using, for example, a setting field 210. Specifically, the administrator 4 designates a communication path for the first communication (hereinafter, referred to as a first communication path) by using, for example, a field 212. If the first communication is to be performed through the designated first communication path, the printing management system 30 outputs the printing information to the mobile terminal 20 in accordance with the setting in the setting field 210. Hereinafter, a condition for the state of the first communication is referred to as a first condition.

The administrator 4 may also set a condition for personal information, confidential information, or the like in the data 60 by using, for example, a setting field 220. Specifically, if the data 60 includes personal information, confidential information, or the like, the administrator 4 designates not outputting of the printing information to the mobile terminal 20. Hereinafter, a condition for the personal information in the data 60 is referred to as a second condition.

The administrator 4 may set a condition for the state of communication between the mobile terminal 20 and the image forming apparatus 50 (hereinafter, referred to as second communication) by using, for example, a setting field 230. Specifically, the administrator 4 designates, for example, a communication path for the second communication (hereinafter, referred to as a second communication path). Accordingly, if the second communication is to be performed through the designated second communication path, the printing management system 30 outputs the printing information from the mobile terminal 20 to the image forming apparatus 50. Hereinafter, the condition for the state of the second communication is referred to as a third condition.

The administrator 4 may also set a condition for the state of the image forming apparatus 50 by using, for example, a setting field 240. Specifically, the administrator 4 designates a safe image forming apparatus 50 by using, for example, the setting field 240. Accordingly, if the mobile terminal 20 is connected to the safe image forming apparatus 50, the printing information is output to the image forming apparatus 50. Note that the safe image forming apparatus 50 means, for example, an image forming apparatus 50 registered in advance in the printing management system 30. Hereinafter, the condition for the state of the image forming apparatus 50 is referred to as a fourth condition.

The approval condition may be set to include not only the first to fourth conditions but also a condition required to ensure the confidentiality of the data 60. The processor 40A in advance receives the approval conditions set from the display screen 200. The approval conditions have been stored, for example, in the storage 40B.

Referring back to FIG. 6, if the conditional approval printing function is enabled (YES in step S212), the processor 40A performs step S214. If the conditional approval printing function is disabled (NO in step S212), the processor 40A performs step S216.

In step S214, the processor 40A adds the set approval condition to the printing information.

In step S216, the processor 40A determines whether the first communication with the mobile terminal 20 serving as the printing-information output destination is established. The information regarding the mobile terminal 20 has been added to the printing information in step S104. If the first communication is established (YES in step S216), the processor 40A performs step S218. If the first communication is not established (NO in step S216), the processor 40A terminates the series of steps.

In step S218, the processor 40A determines whether an approval condition is set for the printing information. If an approval condition is added to the printing information (YES in step S218), the processor 40A executes a process in step S220. If an approval condition is not added to the printing information (NO in step S218), the processor 40A performs step S222. The case where an approval condition is not added to the printing information is, for example, a case where the conditional approval printing function is determined as being disabled in step S212.

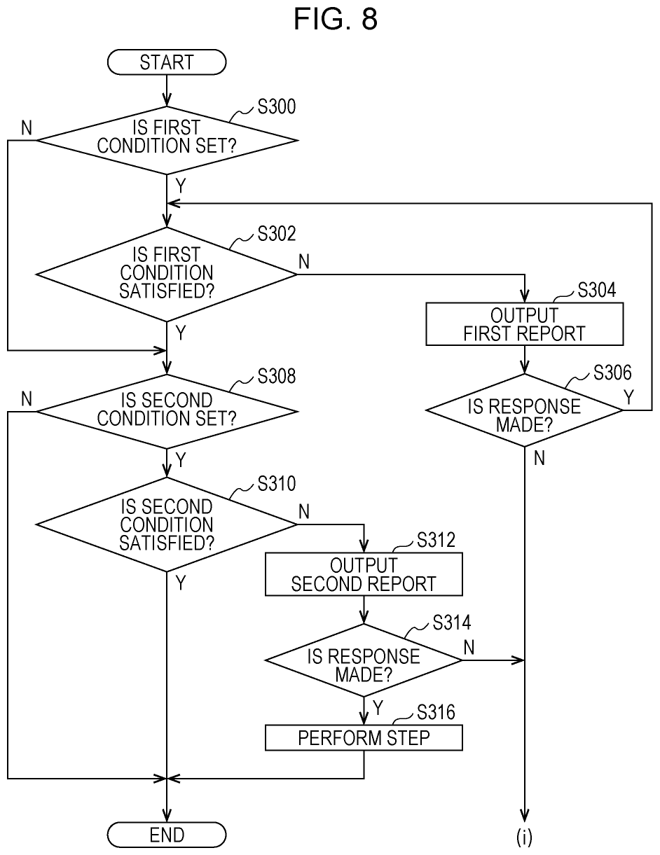

In step S220, the processor 40A executes the process based on the added approval condition. The details of the process in step S220 will be described later (see FIG. 8).

In step S222, the processor 40A outputs the printing information to the mobile terminal 20 serving as the output destination. If step S104 in FIG. 4 is not performed, that is, if the information regarding the mobile terminal 20 serving as the output destination is not added to the printing information because of the negative determination result in step S102, for example, a mobile terminal 20 serving as the output destination is registered separately, and thereafter steps on and after step S216 above are performed.

The details of the process in step S220 will then be described with reference to FIG. 8. In the following description, steps S300 to S316 below are performed by the processor 40A, but at least one step may be performed by the processor 10A.

In step S300, the processor 40A determines whether the first condition is set in the approval condition added to the printing information. If the first condition is set (YES in step S300), the processor 40A performs step S302. If the first condition is not added (NO in step S300), the processor 40A performs step S308.

In step S302, the processor 40A determines whether the established first communication satisfies the first condition. For example, if a password-protected network is set as the first condition on the display screen 200 illustrated in FIG. 7, the processor 40A determines whether the established first communication path is a password-protected network. If the established first communication path is a password-protected network, the established first communication is determined as satisfying the first condition, and thus the determination has an affirmative result. In contrast, if the established first communication is a network other than a password-protected network, the established first communication is determined as not satisfying the first condition, and thus the determination has a negative result.

If the established first communication satisfies the first condition (YES in step S302), the processor 40A performs step S308. If the established first communication does not satisfy the first condition (NO in step S302), the processor 40A performs step S304. The first communication path using the password-protected network is an example of a safe first communication path.

In step S304, the processor 40A gives a first report indicating a measure for satisfying the first condition to the mobile terminal 20.

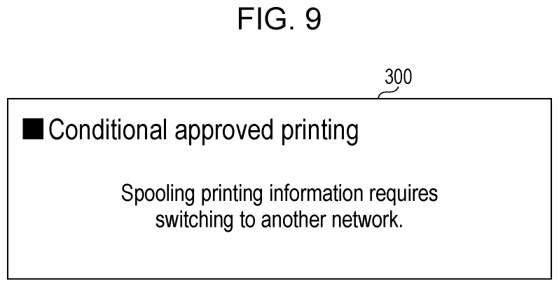

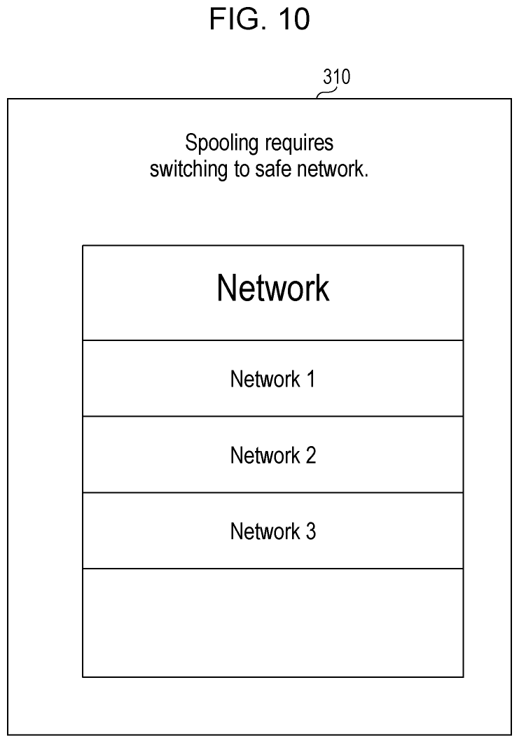

FIG. 9 is a view illustrating an example of the first report given to the mobile terminal 20. A first report 300 illustrated in FIG. 9 has a message indicating that to satisfy the first condition for the conditional approval printing function, switching of the first communication path (described as “network” in FIG. 9) is required. The processor 40A displays, for example, the first report 300 and thereafter gives a first report 310 illustrated in FIG. 10. The first report 310 in FIG. 10 is a report suggesting switching from the established first communication path to a first communication path satisfying the condition. The first report 310 displays a list of candidates for the first communication path satisfying the first condition and, for example, acquired by the mobile terminal 20. The user 2 may perform switching from the first communication path in the established first communication to the first communication path displayed in the first report 310.

In step S306, the processor 40A determines whether a response to the first report is made from the mobile terminal 20. For example, if the processor 40A receives a report indicating that switching of the first communication path has been performed in response to the first report 300 and the first report 310, the processor 40A determines a response as being made. In contrast, if the processor 40A receives a report indicating that, for example, a Cancel button (not illustrated in FIGS. 9 and 10) is pressed in response to the first report 300 or the first report 310, the processor 40A determines a response as not being made.

If a response to the first report is made (YES in step S306), the processor 40A performs step S302. If a response is not made (NO in step S306), the processor 40A terminates the series of steps.

In step S308, the processor 40A determines whether the second condition is set in the approval condition added to the printing information. If the second condition is set (YES in step S308), the processor 40A performs step S310. If the second condition is not added (NO in step S308), the processor 40A performs step S222 illustrated in FIG. 6.

In step S310, the processor 40A determines whether the state of the data 60 included in the printing information satisfies the second condition. For example, if the condition “specific processing is performed of data including personal information or confidential information” (not illustrated) is set as the second condition on the display screen 200 in the setting field 220 illustrated in FIG. 7, determines whether the data 60 includes personal information or confidential information. If the data 60 does not include personal information or confidential information, the state of the data 60 is determined as satisfying the second condition, and thus the determination has an affirmative result. In contrast, if the data 60 includes the personal information or the confidential information, the state of the data 60 is determined as not satisfying the second condition, and thus the determination has a negative result. The personal information, the confidential information, and the like included in the data 60 are an example of specific information.

If the state of the data 60 satisfies the second condition (YES in step S310), the processor 40A performs step S222 in FIG. 6. If the state of the data 60 does not satisfy the second condition (NO in step S310), the processor 40A performs step S312.

In step S312, the processor 40A gives a second report indicating a measure for satisfying the second condition to the mobile terminal 20.

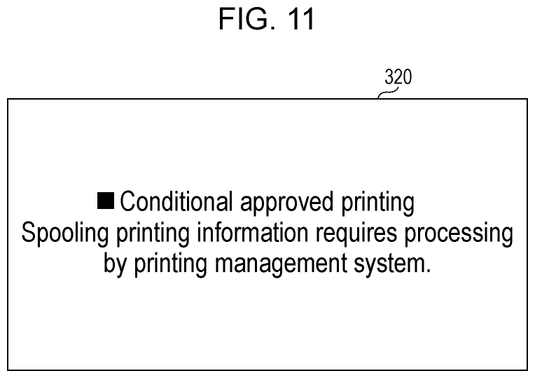

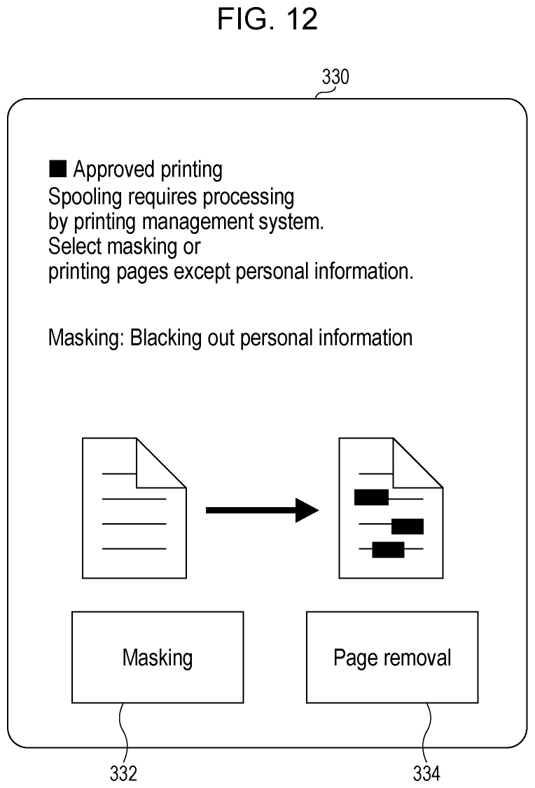

FIG. 11 is a view illustrating an example of the second report given to the mobile terminal 20. A second report 320 illustrated in FIG. 11 has a message indicating that to satisfy the second condition for the conditional approval printing function, processing of the data 60 by the printing management system 30 is required. For example, after giving the second report 320, the processor 40A gives a second report 330 illustrated in FIG. 12. The second report 330 in FIG. 12 is a report suggesting the execution of the processing of the data 60 by the printing management system 30. The second report 330 displays, for example, masking and personal-information page removal in such a manner that the masking or the personal-information page removal is selectable as the processing allowed to be performed of the data 60 by the printing management system 30. The masking means blacking the personal information or the like included in the data 60. The personal-information page removal means removing one or more pages including the personal information, for example, if the data 60 has multiple pages. The user 2 may designate the execution of the processing of the printing information by using the second report 330.

In step S314, the processor 40A determines whether a response to the second report is made from the mobile terminal 20. For example, if the processor 40A receives a report indicating the pressing of a button 332 or a button 334 as a response to the second report 330, the processor 40A determines a response as being made. In contrast, if the processor 40A receives a report indicating the pressing of, for example, a Cancel button (not illustrated) in response to the second report 320 or the second report 330, the processor 40A determines a response as not being made. If a response to the second report is made (YES in step S314), the processor 40A performs step S316. If a response is not made (NO in step S314), the processor 40A terminates the series of steps.

In step S316, the processor 40A performs the masking or the personal-information page removal on the data 60 included in the printing information in response to the received second report. If the masking is performed, for example, data having a blacked out portion corresponding to the personal information in the data 60 is generated. If the personal-information page removal is performed, data in which one or more pages including the personal information are removed is generated. The data generated as the result of the masking or the personal-information page removal is hereinafter referred to as processed data. After step S316 is performed, the data 60 included in the printing information becomes the processed data. The masking and the personal-information page removal lead to generation of data in which the personal information and the confidential information included in the data 60 are removed or hidden.

The details of the process in step S220 illustrated in FIG. 6 have heretofore been described. The process in step S220 causes the printing information the content of which satisfies the first condition and the second condition to be output to the mobile terminal 20.

The mobile terminal 20 having received the printing information output from the printing management system 30 stores the received printing information, for example, in a storage 20B.

A process executed by the mobile terminal 20 to cause the image forming apparatus 50 to print the printing information after the mobile terminal 20 receives the printing information will then be described with reference to FIG. 13.

FIG. 13 is a flowchart illustrating the operations of the mobile terminal 20. The operations illustrated in FIG. 13 are started in response to an application program for the printing management system 30 being started when the user 2 intends to print the printing information output to the mobile terminal 20 and stored, for example, in the storage 20B, by using the image forming apparatus 50. The storage 20B may store multiple pieces of printing information. In the following description, steps S400 to S414 below are performed by the processor 20A, but at least one step may be performed by the processor 40A.

In step S400, the processor 20A determines whether an expiration date added to the stored printing information expires. If there is expired printing information (YES in step S400), the processor 20A performs step S402. If there is not an expired printing information (NO in step S400), the processor 20A performs step S404.

In step S402, the processor 20A deletes the expired printing information from the storage 20B.

In step S404, the processor 20A determines whether communication between the mobile terminal 20 and the image forming apparatus 50 is established. The communication between the mobile terminal 20 and the image forming apparatus 50 is referred to as the second communication. If the second communication is established (YES in step S404), the processor 20A performs step S406. If the second communication is not established (NO in step S404), the processor 20A terminates the series of steps.

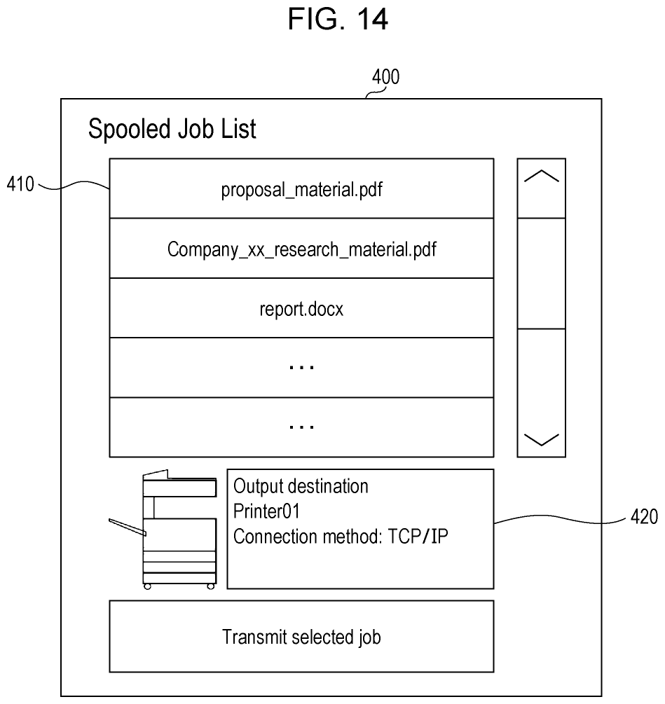

In step S406, the processor 20A displays, on a display 20D, a display screen including a list of pieces of printing information stored in the storage 20B. FIG. 14 is a view illustrating an example of a display image displayed in step S406. A printing information list 410 included in a display screen 400 illustrated in FIG. 14 displays unexpired printing information. Information 420 regarding the image forming apparatus 50 connected in response to the establishment of the second communication is also displayed.

Referring back to the description with reference to FIG. 13, in step S408, the processor 20A determines whether printing information serving as a printing target is selected from the printing information list 410 displayed, for example, on the display screen 400 illustrated in FIG. 14. In the determination, for example, whether the user 2 selects printing-target printing information from among the pieces of printing information displayed in the printing information list 410 is determined. If printing-target printing information is selected (YES in step S408), the processor 20A performs step S410. If printing-target printing information is not selected (NO in step S408), the processor 20A repeats step S408 until printing-target printing information is selected.

In step S410, the processor 20A determines whether one of the third condition and the fourth condition is set as the approval condition for the selected printing information. If one of the third condition and the fourth condition is set for the selected printing information (YES in step S410), the processor 20A executes a process in step S412. If neither of the third condition nor the fourth condition is set for the selected printing information (NO in step S410), the processor 20A performs step S414.

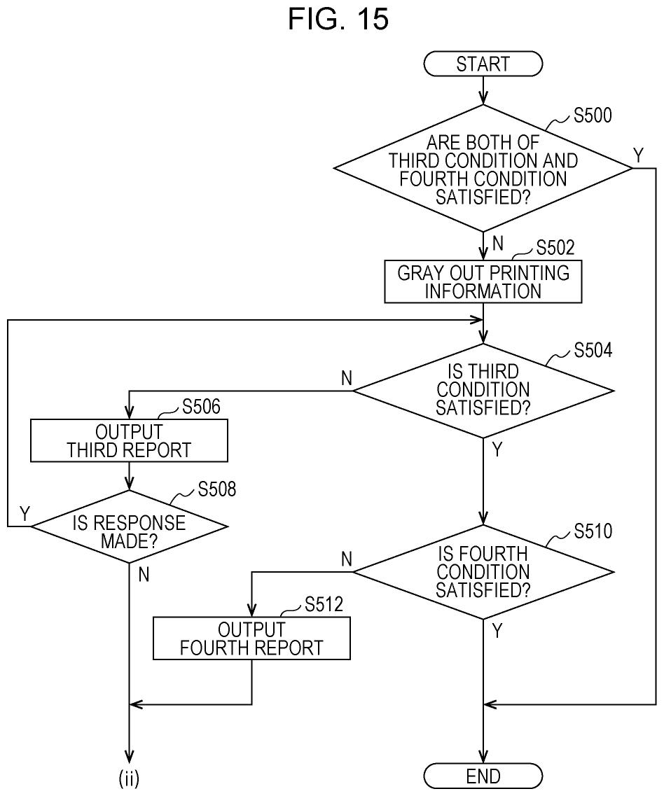

In step S412, the processor 20A executes a process based on at least one of the third condition and the fourth condition set in the approval condition added to the printing information. The details of the process in step S412 will be described later (see FIG. 15).

In step S414, the processor 20A outputs, to the image forming apparatus 50, the selected printing information resulting from step S412 or step S410. Printing information not satisfying any of the third and fourth conditions is not output to the image forming apparatus 50 in step S412. The details thereof are described later.

FIG. 15 is a flowchart illustrating an example of the process executed by the processor 20A in step S412. In the following description, steps S500 and S512 below are performed by the processor 20A, but at least one step may be performed by the processor 40A.

In step S500, the processor 20A determines whether both of the third condition and the fourth condition set for the printing information are satisfied. For example, suppose a case where a password-protected network and a safe image forming apparatus are respectively set as the third condition and the fourth condition. In this settings, if a second communication network for the established second communication is a password-protected network, and, for example, if the image forming apparatus 50 as the connection destination is registered in advance in the printing management system 30, it is determined that both of the third condition and the fourth condition are satisfied. In contrast, for example, if the second communication network for the established second communication is a password-protected network, but if the image forming apparatus 50 as the connection destination has not been registered, the fourth condition is not satisfied, that is, at least one condition is not satisfied, and thus the determination has a negative result. Note a case where, for example, only the third condition is set for the printing information. In this case, if the third condition is satisfied, the determination has an affirmative result. The same holds true for a case where only the fourth condition is set. The second communication path using the password-protected network an example of the safe second communication path.

If both of the third condition and the fourth condition are satisfied (YES in step S500). the processor 20A performs step S414 in FIG. 13. If at least one of the third condition and the fourth condition is not satisfied (NO in step S500), the processor 20A performs step S502.

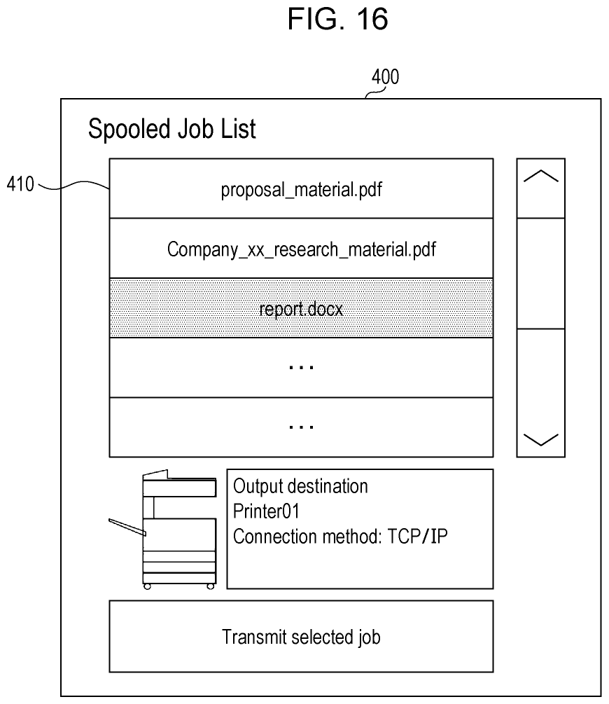

In step S502, the processor 20A displays, on the display screen 400, the selected printing information as printing information not allowed to be output. In an example of displaying the printing information as printing information not allowed to be output, the printing information is grayed out. FIG. 16 is a view illustrating an example of the grayed out printing information. According to the example illustrated in FIG. 16, for example, the printing information “report.docx” selected in step S408 is grayed out in step S502. Graying out the printing information is an example of displaying printing information as not selectable printing information.

In step S504, the processor 20A determines whether the selected printing information satisfies the set third condition. If only the fourth condition is set for the selected printing information, the determination has an affirmative result. If the third condition is satisfied (YES in step S504), the processor 20A performs step S510. If the third condition is not satisfied (NO in step S504), the processor 20A performs step S506.

In step S506, the processor 20A gives, to the display 20D, a third report indicating a measure for satisfying the third condition.

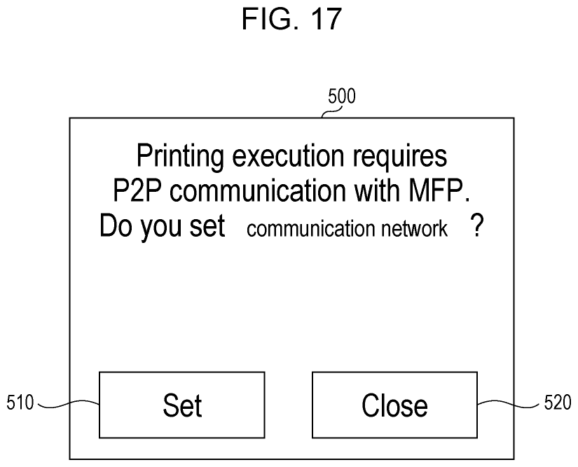

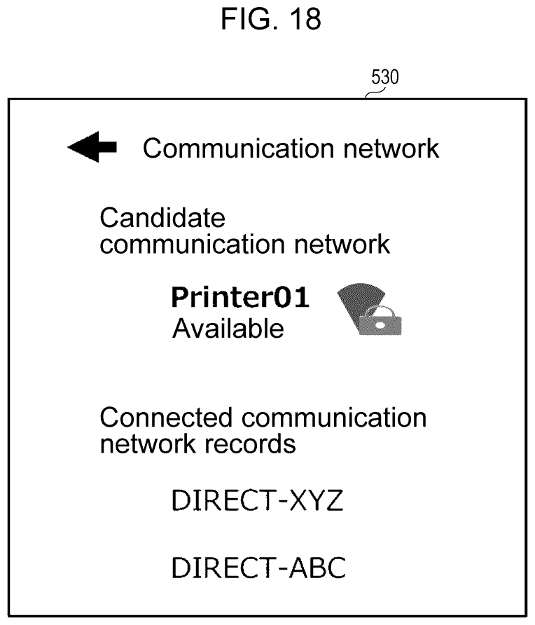

FIG. 17 is a view illustrating an example of the third report given to the display 20D. A third report 500 illustrated in FIG. 17 has a message indicating that to satisfy the third condition for the conditional approval printing function, switching of the second communication path (described as “P2P communication” in FIG. 17) is required. For example, if a button 510 in the third report 500 is pressed, the processor 20A gives a third report 530 illustrated in FIG. 18. The third report 530 in FIG. 18 displays a list of candidates for the second communication path acquired by, for example, the mobile terminal 20 and satisfying the third condition. The user 2 may perform switching from the second communication path in the established second communication to a second communication path displayed in the third report 530.

Referring back to FIG. 15, in step S508, the processor 20A determines whether a response to the third report is made. For example, if the processor 20A receives, in response to the third report 530, a report indicating that switching of the second communication path has been performed, the processor 20A determines a response as being made. In contrast, if the processor 20A receives a report indicating the pressing of, for example, a Close button 520 (not illustrated in FIG. 18) in response to the third report 500 or a fifth report 530, the processor 20A determines a response as not being made.

If a response is made (YES in step S508), the processor 20A performs step S504. If a response is not made (NO in step S508), the processor 20A terminates the series of steps.

In step S510, the processor 20A determines whether the set fourth condition in the approval condition added to the printing information is satisfied. If only the third condition is set for the selected printing information, the determination has an affirmative result. If the fourth condition is satisfied (YES in step S510), the processor 20A performs step S414 illustrated in FIG. 13. If the fourth condition is not satisfied (NO in step S510), the processor 20A performs step S512.

In step S512, the processor 20A gives the display 20D a fourth report indicating a measure for satisfying the fourth condition.

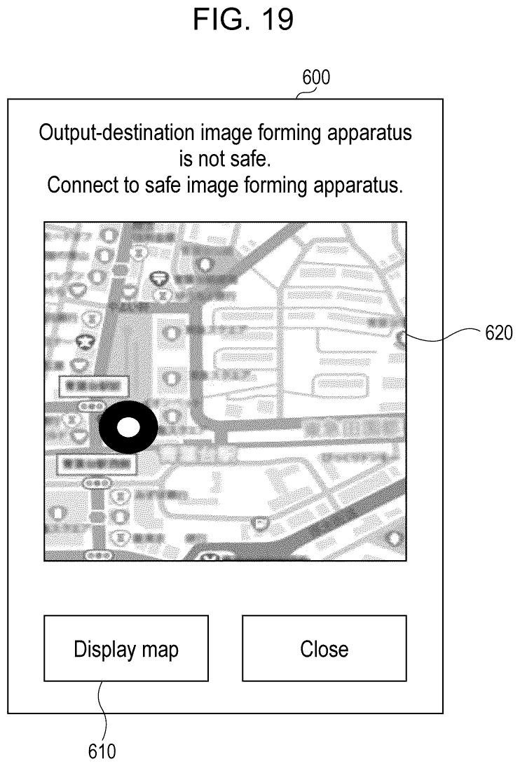

FIG. 19 is a view illustrating an example of the fourth report given to the display 20D. A fourth report 600 illustrated in FIG. 19 has a message indicating that to satisfy the fourth condition for the conditional approval printing function, a connected image forming apparatus 50 is required to be changed. A map 620 representing an installation place of a safe image forming apparatus 50 may be displayed in response to a button 610 in the fourth report 600 being pressed. The user 2 may perform connection to the safe image forming apparatus 50 with the fourth report 600.

After step S512 is performed, the processor 20A executes the process in FIG. 13 again when the user 2 connects the mobile terminal 20 to, for example, the safe image forming apparatus 50.

As described above, if the conditional approval printing function is enabled, the printing information may be printed in response to the approval condition set by the administrator 4 being satisfied.

The exemplary embodiment has heretofore been described; however, the technical scope of the present disclosure is not limited to the scope described in the exemplary embodiment above. Various modifications or improvements may be made to the exemplary embodiment described above without departing from the spirit of the disclosure. An exemplary embodiment to which the modification or the improvement is made may also be included in the technical scope of the present disclosure.

The exemplary embodiment does not limit the disclosure to the claims. Not all of the combinations of the features described in the exemplary embodiment are requisite for the solutions in the disclosure. The above-described exemplary embodiment includes various disclosures, and various disclosures are extracted by combining multiple disclosed components. Even if part of the components described in the exemplary embodiment is deleted, a configuration in which the part of the components is deleted may be extracted as a disclosure as long as effects thereof are exerted.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

For this exemplary embodiment, the configuration in which the application programs are installed in storages 10B, 20B, and 40B has been described; however, the configuration of the disclosure is not limited to this configuration. Each application program according to this exemplary embodiment may be provided in such a manner as to be recorded in a computer readable storage medium. For example, the application program according to this exemplary embodiment may also be provided in such a manner as to be stored in an optical disk such as a compact disc (CD)-ROM or a digital versatile disc (DVD)-ROM or a semiconductor memory such as a universal serial bus (USB) memory or a memory card. The application program according to this exemplary embodiment may be acquired from an external apparatus via communication network I/F units 10E, 20E, and 40E.

For the exemplary embodiment above, the case where the processing in the client computer 10, the mobile terminal 20, and the cloud server 40 is implemented by a software configuration with a computer and by running a program has heretofore been described; however, the present disclosure is not limited to this case. For example, the information processing may be implemented by a hardware configuration or combination of the hardware configuration and the software configuration. In addition, in the description of the exemplary embodiment above, the information processing system is formed from the one cloud server 40 or the one mobile terminal 20. The configuration of the information processing system is not limited to the configuration having one apparatus, and the information processing system may include multiple apparatuses.

The configuration of each of the client computer 10, the mobile terminal 20, the cloud server 40, and the image forming apparatus 50 described for the exemplary embodiment above is an example. It goes without saying that a deletion of unnecessary part and an addition of a new part may be made without departing from the spirit of the present disclosure.

The processing flow of the application programs described for the exemplary embodiment above (see FIGS. 4, 6, 8, 13, and 15) is also an example. It goes without saying that a deletion of an unnecessary step, an addition of a new step, and a processing order change may be made without departing from the spirit of the present disclosure.

Each of the display screens and the reports (see FIGS. 5, 7, 9 to 12, 14, and 16 to 19) generated by the application programs described for the exemplary embodiment above is also an example. It goes without saying that a deletion of an unnecessary element, an addition of a new element, and a design change such as changing an element in an image or enlarging or reducing the element may be made without departing from the spirit of the present disclosure.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### Appendix

(((1)))
An information processing system includes: a processor configured to:
receive printing information and a condition, the printing information including data serving as a printing target, the condition being for managing a state of the data; and
in response to nonsatisfaction of the condition in outputting the received printing information, give a report suggesting a measure for satisfying the condition.
(((2)))
In the information processing system according to (((1))), the processor is configured to:
in response to unsafety of a first communication path to be used for first communication in outputting the printing information through the first communication, the unsafety serving as the nonsatisfaction of the condition, give a report suggesting switching from the first communication path to an acquired safe first communication path.
(((3)))
In the information processing system according to (((1))) or (((2))), the processor is configured to:
in response to inclusion of the data including specific information in the printing information, the inclusion serving as the nonsatisfaction of the condition, give a report in outputting the received printing information, the report suggesting execution of a process for generating data in which the specific information is removed or hidden; and
in response to the execution of the process, output the printing information including the data in which the specific information is removed or hidden.
(((4)))
In the information processing system according to (((1))), the processor is configured to:
in response to unsafety of a second communication path to be used for second communication in outputting the printing information through the second communication, the unsafety serving as the nonsatisfaction of the condition, give a report suggesting switching from the second communication path to an acquired safe second communication path.
(((5)))
In the information processing system according to (((4))), the processor is configured to:
in response to the unsafety of the second communication path, display the printing information as not selectable printing information.
(((6)))
In the information processing system according to any one of (((1))), (((4))), and (((5))), the processor is configured to:
in response to unsafety of an image forming apparatus for printing the printing information, the unsafety serving as the nonsatisfaction of the condition, give a report suggesting change of the image forming apparatus.
(((7)))
In the information processing system according to (((6))), the processor is configured to:
in response to the unsafety of the image forming apparatus, display the printing information as not selectable printing information.
(((8)))
In the information processing system according to (((6))) or (((7))), the processor is configured to:
in response to the unsafety of the image forming apparatus, give a report indicating a place where a safe image forming apparatus is installed.
(((9)))
An information processing program causes a computer to execute a process including:
receiving printing information and a condition, the printing information including data serving as a printing target, the condition being for managing a state of the data; and
in response to nonsatisfaction of the condition in outputting the received printing information, giving a report suggesting a measure for satisfying the condition.

What is claimed is:

1. An information processing system comprising:
a processor configured to:
receive printing information and a condition, the printing information including data serving as a printing target, the condition being for managing a state of the data; and
in response to nonsatisfaction of the condition in outputting the received printing information, give a report suggesting a measure for satisfying the condition.

2. The information processing system according to claim 1,
wherein the processor is configured to:
in response to unsafety of a first communication path to be used for first communication in outputting the printing information through the first communication, the unsafety serving as the nonsatisfaction of the condition, give a report suggesting switching from the first communication path to an acquired safe first communication path.

3. The information processing system according to claim 2,
wherein the processor is configured to:
in response to inclusion of the data including specific information in the printing information, the inclusion serving as the nonsatisfaction of the condition, give a report in outputting the received printing information, the report suggesting execution of a process for generating data in which the specific information is removed or hidden; and
in response to the execution of the process, output the printing information including the data in which the specific information is removed or hidden.

4. The information processing system according to claim 1,
wherein the processor is configured to:
in response to unsafety of a second communication path to be used for second communication in outputting the printing information through the second communication, the unsafety serving as the nonsatisfaction of the condition, give a report suggesting switching from the second communication path to an acquired safe second communication path.

5. The information processing system according to claim 4,
wherein the processor is configured to:
in response to the unsafety of the second communication path, display the printing information as not selectable printing information.

6. The information processing system according to claim 1,
wherein the processor is configured to:
in response to unsafety of an image forming apparatus for printing the printing information, the unsafety serving as the nonsatisfaction of the condition, give a report suggesting change of the image forming apparatus.

7. The information processing system according to claim 6,
wherein the processor is configured to:
in response to the unsafety of the image forming apparatus, display the printing information as not selectable printing information.

8. The information processing system according to claim 6,
wherein the processor is configured to:
in response to the unsafety of the image forming apparatus, give a report indicating a place where a safe image forming apparatus is installed.

9. The information processing system according to claim 7,
wherein the processor is configured to:
in response to the unsafety of the image forming apparatus, give a report indicating a place where a safe image forming apparatus is installed.

10. A non-transitory computer readable medium storing a program causing a computer to execute a process for information processing, the process comprising:
receiving printing information and a condition, the printing information including data serving as a printing target, the condition being for managing a state of the data; and
in response to nonsatisfaction of the condition in outputting the received printing information, giving a report suggesting a measure for satisfying the condition.

11. An information processing method comprising:
receiving printing information and a condition, the printing information including data serving as a printing target, the condition being for managing a state of the data; and
in response to nonsatisfaction of the condition in outputting the received printing information, giving a report suggesting a measure for satisfying the condition.
